(19) United States
(12) Patent Application Publication
(10) Pub. No.: US 2009/0202899 A1
(43) Pub. Date: Aug. 13, 2009

(54) Electrical apparatus with integral thin film solid state battery and methods of manufacture

(76) Inventor: Michael F. Pyszczek, Le Roy, NY (US)

Correspondence Address: Anne M. Schneiderman;LAW OFFICES OF ANNE M. SCHNEIDERMAN PH.D., P.O Box 422, Ithaca, NY, 14851-0422, US

(21) Appl. No.: 12/029,263

(22) Filed: Feb. 11, 2008

(51) Int. Cl. H01M 6/42; H01M 4/02; H01M 2/08; H01M 6/02; H01M 2/14

(52) U.S. Cl. 429/152; 429/209; 429/185; 429/246; 427/58

(57) ABSTRACT

The invention provides a thin film solid state (TFSS) battery that can conform to the surface of an apparatus having a complex, three-dimensional surface. The invention also provides methods for constructing the thin film solid state battery by forming components directly onto a substrate of a complex three-dimensional shape. The resulting thin film solid state battery can be used to power electronics associated with a variety of devices such as medical devices.

### 1. TECHNICAL FIELD

The present invention relates to a thin film, flexible power source that can be assembled directly onto the surface of an apparatus having complex geometry. The invention also relates to methods for assembling a power source directly onto the surface of an apparatus having complex geometry. The invention further relates to an apparatus having complex geometry with an integral thin film, flexible power source.

### 2. BACKGROUND OF THE INVENTION

Thin film, solid state rechargeable batteries offer several advantages when used in devices, particularly in those that are implanted or applied to the human body. Rapid charge times, high current delivery capability, very high cycle life, and low self-discharge are all advantageous features of current thin film battery systems over conventional battery technologies.

Li-ion rechargeable batteries utilizing a polymer electrolyte have been manufactured in thin, flexible form factors (Gozdz, U.S. Pat. No. 5,552,239). Primary (non-rechargeable) batteries using a lithium metal anode have also been produced in planar geometries (Bruder, U.S. Pat. No. 4,429,026). Flexible electrode components are well known in the industry and serve as the basis for cylindrical “jelly-roll” cells. In all of these examples, the components or cells are manufactured prior to incorporation within an apparatus.

Solid state battery technology employing the use of vapor deposition or other techniques to construct the layers of battery components directly onto a substrate has enabled manufacturers to construct a battery directly onto an electronic circuit or device enclosure (Yoon, U.S. Pat. No. 6,264,709). The use of LiPON solid electrolyte technology (Bates, U.S. Pat. No. 5,597,660) has enabled batteries with high performance features, although the glass nature of the LiPON is a potential source of failure when the planar battery is flexed. Due to the LiPON layer's potential to fracture, however, the bend radius of so-called flexible batteries is limited and conformation to complex three-dimensional shapes is restricted.

Devices used in the medical field are often required to take on complex shapes to conform to the contour of a particular area of the human anatomy. For example, electronic control devices for use by quadriplegic patients (paraplegic assist devices) can be potentially located in the upper palate of the mouth, where they preferably conform to the shape of the upper palate. In such paraplegic assist devices, the interface can be formed to match the contour of the upper palate of the user's mouth as described by Moise (U.S. Pat. No. 7,071,844), and Dordick (U.S. Pat. No. 5,689,246). Other examples are motor-driven devices used in enhancing distraction osteogenesis that are applied directly to a bone surface for the purpose of repairing complicated compound fractures such as those received by soldiers in battle.

Other medical devices are frequently custom manufactured to meet the physical requirements of a specific patient. Common examples are dental implants and orthodontic appliances. Significant advantages exist with devices that can function inside the mouth or that can be implanted. Wireless communication offers the elimination of a transcutaneous connection, thus removing an infection source. In the case of a tongue-controlled device worn on the roof of the mouth, a highly concealed interface mechanism is provided. A wireless design, however, requires that the device be equipped with an internal power source. Fortune (U.S. Pat. No. 5,523,745) discloses the use of commercially available button cells in such an application, and describes the limitations that battery life place on the device. The use of button cells or any other commercial battery requires that the appliance be equipped with a compartment to hold the battery and that it be isolated from the local environment to avoid short circuits caused by contacts with bodily fluids. The battery enclosure, as described by Fortune, adds significant volume and complexity to the device.

Incorporation of thin film batteries in medical devices has been previously disclosed by Schmidt (U.S. Pat. No. 6,782,290), who describes a battery structure that is incorporated onto a circuit board. Additional descriptions of medical devices employing batteries integrated into their structure are described by Jensen (U.S. Pat. No. 7,157,187) and Schmidt (U.S. published patent application 20040220643). Jensen (U.S. Pat. No. 7,157,187) and Schmidt (U.S. Pat. No. 6,782,290 and U.S. published patent application 20040220643) disclose that the battery is planar or has a single curved surface that is consistent with an apparatus of simple geometry.

There is therefore a need in the art for a power source capable of being incorporated into the construction of an apparatus comprising a complex three-dimensional form factor. Current technology disclosed by Jensen (U.S. Pat. No. 6,986,965) describes planar or flat batteries along with those curved in one plane. The latter may be formed through a roll-to-roll process also described by Bates (U.S. Pat. No. 5,445,906). While these technologies indicate that a battery can be operationally incorporated on a curved surface, they fail to address the existing requirements of devices comprising three-dimensional surfaces.

Citation or identification of any reference in Section 2, or in any other section of this application, shall not be considered an admission that such reference is available as prior art to the present invention.

### 3. SUMMARY OF THE INVENTION

A thin film solid state (TFSS) battery is provided that has a three-dimensional shape that is dictated by the complex contour(s) of the surface on which an apparatus incorporating the battery will be disposed. In one embodiment, the TFSS battery comprises: a substrate layer comprising an upper surface and a lower surface; and a multi-layer cell, the multi-layer cell comprising:
i. a layer of electrically conductive material comprising an upper surface and a lower surface;
ii. a first terminus layer comprising electrically conductive material, a first exposed terminus, an upper surface and a lower surface, wherein the first exposed terminus is capable of functioning as an electrical connection;
iii. a cathode layer comprising electrically conducting intercalation material, an upper surface and a lower surface;
iv. an electrolyte layer comprising an upper surface and a lower surface;
v. an anode layer comprising electrically conductive, chemically active material, an upper surface and a lower surface, wherein the anode layer is aligned with the cathode layer thereby allowing ion flow between the anode layer and the cathode layer through the electrically conducting intercalation material; and
vi. a second terminus layer comprising electrically conductive material, a second exposed terminus, an upper surface and a lower surface wherein the second exposed terminus is capable of functioning as an electrical connection.

In another embodiment,
i. the lower surface of the layer of electrically conductive material is disposed on the upper surface of the substrate layer;
ii. the lower surface of the first terminus layer is disposed on the upper surface of the layer of electrically conductive material;
iii. the lower surface of the cathode layer is disposed on the upper surface of the first terminus layer so that the exposed terminus of the first terminus layer is exposed;
iv. the lower surface of the electrolyte layer is disposed on the upper surface and sides of the cathode layer;
v. the lower surface of anode layer is disposed on the upper surface of the electrolyte layer; and
vi. the lower surface of the second terminus layer is disposed on the upper surface of the anode layer.

In another embodiment,
i. the lower surface of the layer of electrically conductive material is disposed on the upper surface of the substrate layer;
ii. the lower surface of the first terminus layer is disposed on the upper surface of the layer of electrically conductive material;
iii. the lower surface of the anode layer is disposed on the upper surface of the first terminus layer so that the exposed terminus of the first terminus layer is exposed;
iv. the lower surface of the electrolyte layer is disposed on the upper surface and sides of the anode layer;
v. the lower surface of cathode layer is disposed on the upper surface of the electrolyte layer; and
vi. the lower surface of the second terminus layer is disposed on the upper surface of the cathode layer.

In another embodiment, the TFSS battery can additionally comprise a sealing layer comprising non-conductive, protective material, an upper surface and a lower surface, wherein the lower surface of the sealing layer seals the upper surface of the second terminus layer and exposed edges of layers disposed beneath the second terminus layer, and the first exposed terminus and the second exposed terminus are not sealed by the lower surface of the sealing layer.

In another embodiment, the layer of electrically conductive material can be the substrate layer.

In another embodiment, the upper surface of the substrate layer can comprise an insulating layer.

In another embodiment, the upper surface of the first terminus layer can comprise an insulating layer.

In another embodiment, the TFSS battery can comprise a plurality of multi-layer cells, wherein each of the first terminus layers of each multi-layer cell of the plurality is connected in series or in parallel to at least one other first terminus layer of a multi-layer cell of the plurality, and each of the second terminus layers of each multi-layer cell of the plurality is connected in series or in parallel to at least one other second terminus layer of a multi-layer assembly of the plurality.

In another embodiment, the TFSS battery can comprise a single substrate layer. In another embodiment, the TFSS battery can comprise two or more substrate layers.

Also provided are methods for constructing a TFSS battery on a surface of an apparatus having a complex, three-dimensional surface.

In one embodiment, the components of the TFSS battery can be deposited directly onto a surface of a complex three-dimensional shape and formed or molded in accordance with the shape or contours of the application site.

A method for producing a TFSS battery that conforms to a contour of interest is also provided. The method can comprise the steps of:
Mapping the contour of interest;
Recording the shape of the contour of interest;
Acquiring data from the recording that describes the contour of interest;
Producing a representation of the contour of interest;
Determining a desired shape for the substrate layer from the data describing the contour of interest;
Forming the substrate layer into the desired shape, wherein the substrate layer has an upper surface and a lower surface; and
Forming a multi-layer cell, the multi-layer cell comprising:
   i. a layer of electrically conductive material comprising an upper surface and a lower surface;
   ii. a first terminus layer comprising electrically conductive material, a first exposed terminus, an upper surface and a lower surface, wherein the first exposed terminus is capable of functioning as an electrical connection;
   iii. a cathode layer comprising electrically conducting intercalation material, an upper surface and a lower surface;
   iv. an electrolyte layer comprising an upper surface and a lower surface;
   v. an anode layer comprising electrically conductive, chemically active material, an upper surface and a lower surface, wherein the anode layer is aligned with the cathode layer thereby allowing ion flow between the anode layer and the cathode layer through the electrically conducting intercalation material; and
   vi. a second terminus layer comprising electrically conductive material, a second exposed terminus, an upper surface and a lower surface wherein the second exposed terminus is capable of functioning as an electrical connection.

Also provided is an apparatus incorporating a TFSS battery of the invention and a method for constructing an apparatus incorporating a TFSS battery. The apparatus can comprise an electrically powered device and a TFSS battery operatively connected to the electrically powered device. The TFSS battery can conforms to a contour of interest.

Examples of such an apparatus include, but are not limited, to an apparatus that requires an internal power source. The TFSS battery can be used to power electronics associated with a variety of devices such as medical devices that employ an internal power source, including, but not limited to, any device known in the art for cardiac rhythm management (e.g., cardiac pacemaking, and cardioverter defibrillation), neurostimulation, pumps for dispensing drug or pharmaceutical compositions (e.g., insulin), diagnostic sensors (e.g., implanted to record glucose content, oxygen sensor, telemetry); regeneration and repair devices (e.g., bone repair, distractive osteogenesis); tissue repair (electrical pulses for regeneration of neurons, connective tissue, etc.), and human interface applications (e.g., paraplegic assist device disposed on the upper palate of the mouth).

An apparatus comprising an electricity-generating device and a TFSS battery operatively connected to the electricity-generating device, and a method for constructing such an apparatus are also provided. The TFSS battery can conform to a contour of interest. The electricity-generating device can be, for example, a photovoltaic array, a DC power supply, or a charging battery.

### 4. BRIEF DESCRIPTION OF THE DRAWINGS

The present invention is described herein with reference to the accompanying drawings, in which similar reference characters denote similar elements throughout the several views. It is to be understood that in some instances, various aspects of the invention may be shown exaggerated or enlarged to facilitate an understanding of the invention.

FIG. 1 shows a flow chart for a method that can be used to produce a substrate matched to the complex geometry of the application site. See Section 5.3 for details.

FIG. 2 shows a flow chart for a formation technique in which a reproduction of the surface geometry can be made using a substrate material. See Section 5.3 for details.

FIG. 3 shows an embodiment of the method for producing an apparatus with an integral TFSS battery power source that has a complex geometric shape. See Section 5.3 for details.

FIG. 4 is a schematic of a planar thin film battery as designed by Excellatron Solid State Inc. (Atlanta, Ga.). See Section 5.3 for details.

FIG. 5 illustrates an apparatus with an integral embodiment of the TFSS battery of the present invention. See Section 5.3 for details.

FIG. 6 shows a method for producing a thin film battery on a geometrically complex surface. See Section 5.3 for details.

FIG. 7 shows a human interface device comprising a TFSS battery. See Section 6, Example 1 for details.

FIG. 8 shows an example of a deep brain stimulation device comprising a TFSS battery. See Section 6, Example 2 for details.

### 5. DETAILED DESCRIPTION OF THE INVENTION

5.1 TFSS Battery Layers and Methods for Depositing Layers

A TFSS battery is provided that can comprise a substrate layer comprising an upper surface and a lower surface and a multi-layer cell, the multi-layer cell comprising:
a layer of electrically conductive material comprising an upper surface and a lower surface;
a first terminus layer comprising electrically conductive material, a first exposed terminus, an upper surface and a lower surface, wherein the first exposed terminus is capable of functioning as an electrical connection;
a cathode layer comprising electrically conducting intercalation material, an upper surface and a lower surface;
an electrolyte layer comprising an upper surface and a lower surface;
an anode layer comprising electrically conductive, chemically active material, an upper surface and a lower surface, wherein the anode layer is aligned with the cathode layer thereby allowing ion flow between the anode layer and the cathode layer through the electrically conducting intercalation material; and
a second terminus layer comprising electrically conductive material, a second exposed terminus, an upper surface and a lower surface wherein the second exposed terminus is capable of functioning as an electrical connection.

In another embodiment, a TFSS battery is provided wherein:
i. the lower surface of the layer of electrically conductive material is disposed on the upper surface of the substrate layer;
ii. the lower surface of the first terminus layer is disposed on the upper surface of the layer of electrically conductive material;
iii. the lower surface of the cathode layer is disposed on the upper surface of the first terminus layer so that the exposed terminus of the first terminus layer is exposed;
iv. the lower surface of the electrolyte layer is disposed on the upper surface and sides of the cathode layer;
v. the lower surface of anode layer is disposed on the upper surface of the electrolyte layer; and
vi. the lower surface of the second terminus layer is disposed on the upper surface of the anode layer.

The substrate layer can comprise one or more materials such as glasses, ceramics or polymers (see, e.g., Zhang, J. G. U.S. published patent application 20040018424, Zhang, U.S. Pat. No. 6,835,493) or metals (see, e.g., Johnson, U.S. published patent application 20020187399, Johnson, U.S. Pat. No. 6,242,129).

The layer of electrically conductive material, the first terminus layer and/or the second terminus layer (or anode current collector) can comprise any electrically conductive material known in the art, including but not limited to metals such as nickel, copper, or mixed metal alloys.

The electrolyte layer can provide ionic conductivity and physical separation of the anode layer and cathode layer. The electrolyte layer can comprise, for example, a lithium intercalation compound such as lithium phosphorusoxynitride (LiPON) formed in-situ through techniques described by Bates (U.S. Pat. No. 5,597,660).

The anode layer can comprise any anode material known in the art, e.g., lithium or other group 1A metal, and can be deposited, for example, over a separator layer.

The cathode layer can comprise a layer of electroactive material that can be deposited onto the surface of a substrate or onto a current collector layer deposited onto a substrate. The cathode layer can comprise any cathode or cathode-reactive materials such as known in the art such as a metal or mixed metal oxide (e.g., manganese dioxide) or a fluorinated carbon. In one embodiment, the cathode layer can comprise a metal or mixed-metal oxide having amorphous fine-grain morphology.

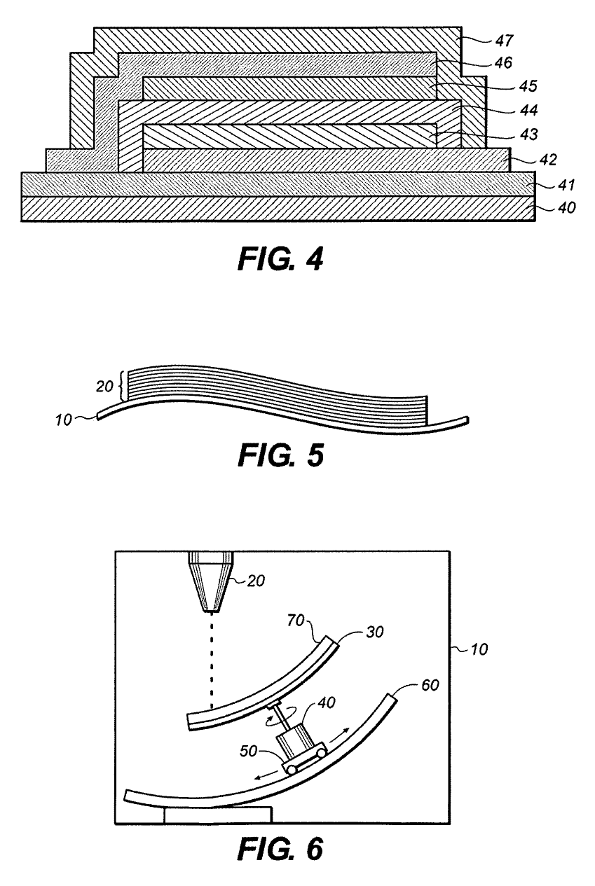

In certain embodiments, the TFSS battery can further comprise a sealing, encapsulation or insulating layer. The sealing layer can comprise a non-conductive, protective material, an upper surface and a lower surface, wherein the lower surface of the sealing layer is chemically compatible with the sealing layer and the other underlying layers of the TFSS battery, seals the upper surface of the second terminus layer and the edges of underlying layers (e.g., FIG. 4, layers 40-47), and does not seal the first exposed terminus and the second exposed terminus.

One or more sealing, encapsulation or insulating layers can be deposited over or around the TFSS battery. Sealing, encapsulation or insulating layers can comprise a polymeric, ceramic, or glass material, e.g., polyethylene, TEFLON®, parylene, or other biocompatible materials. Sealing the TFSS battery with a sealing layer can allow it to function under conditions in which it could be exposed to moisture or bodily fluids. Various methods for sealing the surface of batteries are commonly known in the art. For example, the use of a parylene barrier film has been described by Bates (U.S. Pat. No. 5,561,004). Johnson (U.S. Pat. No. 6,387,563) describes the use of an epoxy seal. Zhang, J. G. (U.S. published patent application 20070094865) discloses the use of a multi-layered packaging foil to seal a thin film battery. The TFSS battery can be sealed from atmospheric contamination by methods known in the art for sealing thin film batteries in planar configurations as described by Bates (U.S. Pat. No. 6,994,933), in which a vapor barrier is applied specifically to a thin film cell deposited onto a flat substrate.

In certain embodiments, the first layer of electrically conductive material can also serve as the substrate layer. The substrate layer can be inert or electrically conductive, and can comprise metal, ceramic or polymer.

The upper surface of the substrate layer and/or the upper surface of the first terminus layer can comprise a protective, electrically insulating layer.

In one embodiment, the TFSS battery can comprise a single cell with a single cathode and a single anode, for example, if the apparatus to which the TFSS battery is customized requires a low voltage source.

In another embodiment, the TFSS battery can comprise a plurality of multi-layer cells, e.g., a stack of cells. Each of the first terminus layers of each multi-layer cell of the plurality can be operatively connected in series or in parallel to at least one other first terminus layer of the multi-layer cell of the plurality. Each of the second terminus layers of each multi-layer cell of the plurality can be operatively connected in series or in parallel to at least one other second terminus layer of at least one other the multi-layer cell of the plurality. The operative connections can be in series and/or parallel electrical configurations for higher voltage or current applications (see, e.g., Bates U.S. Pat. No. 5,569,520).

An operative connection can be any connection known in the art employing physical contact, such as a wired connection, a welded connection, a soldered connection, a pressure connection, or a spring-loaded connection.

For example, two cells with a nominal voltage of 3 volts and a capacity of 5 milliamp hours, when connected in a series configuration, would produce a battery of 6 volts and 5 milliamp hours. The same cells configured in parallel would yield a battery of 3 volts and a 10 milliamp hour capacity. As will be apparent to one of ordinary skill in the art, multiple cells can be configured in a variety of series and/or parallel arrangements to produce a TFSS battery of desired voltage and capacity to meet the desired electrical requirements of an apparatus.

In certain embodiments, the various layers of the TFSS battery can be deposited onto or bound to the surface of the substrate through a deposition process. Methods of depositing the individual TFSS battery layers can include art-known methods such as DC magnetron sputtering, RF sputtering, reactive formation, chemical vapor deposition, evaporation deposition, spray coating, and spin coating, reaction, and ablation (e.g., laser ablation) can also be used to deposit TFSS battery layers (see, e.g., Bates, U.S. Pat. No. 5,567,210).

Additionally, layers of the TFSS battery can be printed, sprayed, molded, cast, or spun on.

Certain manufacturing techniques that can be employed in forming the layers of planar batteries can also be used for forming the layers of a TFSS battery. Methods for depositing various battery layers are known in the art and have been disclosed by, e.g., Bates (U.S. Pat. No. 5,597,660). Additional deposition methods have been disclosed by Zhang, J. G. (U.S. Pat. No. 6,886,240) and Zhang, H. (U.S. published patent application 20070125638). Other methods for depositing thin films are known in the art, e.g., lithographic methods described by Lewis (U.S. Pat. No. 6,861,170) and printing or material transfer processes such as those described by Miekka et al. (U.S. Pat. No. 6,045,942) and Lake (U.S. Pat. No. 5,642,468).

In another embodiment, the TFSS battery can comprise layers that are inverted, e.g., the anode and the cathode layers can be switched with respect to order and/or deposition. There can be embodiments that dictate that the anode layer be deposited first and the cathode layer be deposited subsequently. An advantage of depositing the cathode layer first is that it can be annealed at a high temperature prior to assembly of the remaining layers. The lithium in a lithium anode melts at 180° C., so that it could not withstand annealing.

For example, a TFSS battery can be constructed wherein:
i. the lower surface of the layer of electrically conductive material is disposed on the upper surface of the substrate layer;
ii. the lower surface of the first terminus layer is disposed on the upper surface of the layer of electrically conductive material;
iii. the lower surface of the anode layer is disposed on the upper surface of the first terminus layer so that the exposed terminus of the first terminus layer is exposed;
iv. the lower surface of the electrolyte layer is disposed on the upper surface and sides of the anode layer;
v. the lower surface of cathode layer is disposed on the upper surface of the electrolyte layer; and
vi. the lower surface of the second terminus layer is disposed on the upper surface of the cathode layer.

The sequence of the steps of the deposition process can also be changed so that the anode material can be deposited on the substrate. In this configuration, the substrate will be of negative polarity and may be preferred in some applications. Preferences for battery case polarity are known in the art and those preferences can be accommodated through changes to the layer deposition sequence.

One advantage of the TFSS battery provided by the present invention is that the overall volumes for devices comprising the battery are greatly reduced in comparison to similar devices currently known in the art. For example, Fortune (U.S. Pat. No. 5,523,745) discloses an assist device that incorporates a battery and that is worn on the upper palate of the mouth. The Fortune device requires a rectangular housing to hold and isolate the battery cells. The housing protrudes from the device, causing increased discomfort for the user. The TFSS battery of the invention, by contrast, can be located directly on the substrate formed to comply or conform to the surface onto which the TFSS battery is disposed.

Another advantage of the TFSS battery and the methods for making the TFSS battery provided herein is apparent when the unique contour or shape of each potential application site is considered, such as in a medical device application. For example, the three-dimensional surface contour of a human skull will vary with each individual. An apparatus such as a neurostimulator with an integrated TFSS battery can be used to reduce the apparatus volume and improve the cosmetic nature of the appliance.

5.2 Methods for Constructing the TFSS Battery

A TFSS battery is provided that has a desired three-dimensional shape or geometry. Methods for constructing the TFSS battery are also provided. The TFSS battery can be customized or adapted to fit the complex contour(s) of a desired surface on which an apparatus incorporating the TFSS battery will be disposed. The shape of the apparatus, for example, can be defined by or conform to the structure on which the apparatus is attached.

The TFSS battery can be constructed on the inner surface or the outer surface of an apparatus (or device enclosure) that has a complex geometrical shape. While TFSS batteries have been previously known in the art to be flexible or conformal, application of a TFSS battery to a complex shape has not been achieved previously in the art with a pre-formed battery.

Fabrication of a TFSS battery or an apparatus comprising a TFSS battery can be accomplished by methods known in the art. A surface contour of interest or a desired three-dimensional geometry can be mapped or surveyed by methods known in the art, e.g., by forming an impression mold or by mapping by image scanning. An impression mold can be formed in instances where access to the site is possible. Application of a moldable substance such as clay or plaster can be used to record or capture the surface contour. When access to the site is not possible, the shape can be recorded or rendered optically. Scanning and digitization of the surface on which the apparatus is to be applied can be performed using standard techniques known in the art. For example, imaging techniques such as X-ray imaging, MRI, CT, or PET can be used to acquire data that describes the contour.

Once a surface contour of interest has been defined, the substrate layer can be formed into a desired shape by any of a variety of forming methods known in the art, including molding, vacuum forming, and pressing. These methods can be applied to solid models formed through the use of direct access to the application site. When imaging techniques are used, modeling software such as 3D Doctor (Able Software Corp., Lexington, Mass.) can be used to form a three-dimensional virtual image of the surface. The data can be translated into a solid model of the surface using conventional methods, such as through the use of rapid prototyping technology such as stereo lithography. The solid model of the surface of the application site can then be used, using standard techniques known in the art, to shape the substrate, e.g., by pressing, extruding, casting, deposition, stamping, molding, machining, or other art-known mechanical means of shaping the substrate material.

In one embodiment, the method for producing a TFSS battery that conforms to a contour of interest can comprise:
Mapping the contour of interest;
Recording the shape of the contour of interest;
Acquiring data from the recording that describes the contour of interest;
Producing a representation of the contour of interest;
Determining a desired shape for the substrate layer from the data describing the contour of interest;
Forming the substrate layer into the desired shape, wherein the substrate layer has an upper surface and a lower surface;
Forming a multi-layer cell, the multi-layer cell comprising:
   a layer of electrically conductive material comprising an upper surface and a lower surface;
   a first terminus layer comprising electrically conductive material, a first exposed terminus, an upper surface and a lower surface, wherein the first exposed terminus is capable of functioning as an electrical connection;
   a cathode layer comprising electrically conducting intercalation material, an upper surface and a lower surface;
   an electrolyte layer comprising an upper surface and a lower surface;
   an anode layer comprising electrically conductive, chemically active material, an upper surface and a lower surface, wherein the anode layer is aligned with the cathode layer thereby allowing ion flow between the anode layer and the cathode layer through the electrically conducting intercalation material; and
   a second terminus layer comprising electrically conductive material, a second exposed terminus, an upper surface and a lower surface wherein the second exposed terminus is capable of functioning as an electrical connection.

5.3 Apparatuses Comprising TFSS Batteries and Methods for Constructing Apparatuses Comprising TFSS Batteries

An apparatus comprising a TFSS battery is also provided. In one embodiment, the apparatus can comprise an electrically powered device and a thin film solid state (TFSS) battery operatively connected to the electrically powered device. In one embodiment, a portion of the electrically powered device is the substrate layer.

An operative connection can be any connection known in the art employing physical contact, such as a wired connection, a welded connection, a soldered connection, a pressure connection, or a spring-loaded connection.

In another embodiment, the apparatus can comprise an electricity-generating device; and a TFSS battery operatively connected to the electricity-generating device. A portion of the electricity-generating device can be the substrate layer. According to this embodiment, the TFSS battery can store electricity generated by the electricity-generating device.

In one embodiment, the apparatus can have a complex geometry in which a TFSS battery can be assembled directly onto the surface or within the contours of the apparatus. One embodiment provides an apparatus comprising a TFSS battery, wherein the TFSS battery is designed to match the complex shape of a surface or contour to which the apparatus is to be attached. A method for constructing an apparatus comprising a TFSS battery is also provided.

In one embodiment, the method can comprise mapping the surface to which the apparatus is to be attached by, e.g., a non-contact imaging technique; recording the shape of the surface; acquiring data from the recording that describes the shape of the surface; determining a desired shape for the substrate layer from the data describing the surface; forming the substrate layer into the desired shape; and forming a multi-layer cell for the TFSS battery, as described hereinabove.

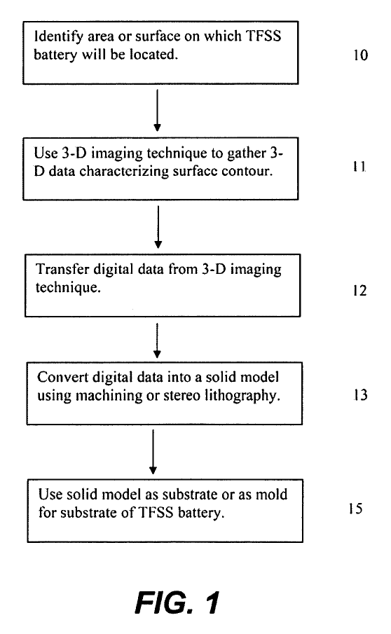

The flow chart in FIG. 1 shows that a three-dimensional imaging technique (such as MRI, CT, PET or similar non-contact imaging technique) can be used to obtain geometric or 3-D data 11 useful in the reproduction of a surface contour of interest 10 on which a TFSS battery will be located. In the example shown in FIG. 1, a complex three-dimensional contour could be, for example, the surface of the skull. By using digital data obtained from the three-dimensional imaging technique 12, a solid model can be constructed 13, e.g., by converting the digital data into a solid model through machining, stereo lithography, or any other technique known in the art. The solid model can then be used as a mold for the substrate of the TFSS battery or as the substrate itself for the TFSS battery. For example, the solid model can be used as a pattern for the machining of metal into the apparatus case to be placed, e.g., on the surface of the skull.

As described above, the TFSS battery can comprise layers that can be formed, for example, by depositing the layers onto the surface of the apparatus substrate. Thus the TFSS battery, in certain embodiments, can be integral to an apparatus. An apparatus comprising the TFSS battery can additionally comprise electronic components and/or mechanical components for use in operating the apparatus. Non-limiting examples include circuit boards, sensors, or mechanical actuators that can be attached or installed, e.g., by gluing, applying an adhesive, molding, welding, and other forms of mechanical fastening known in the art.

In certain embodiments, the apparatus can further comprise a case, an integrated power source, a control circuit, an interface or lead to the area of interest (e.g., the area of therapy), a recharging circuit, and/or a recharging mechanism comprising an antenna or direct electrical connection. Depending on the therapy being delivered, a combination of these components can be used.

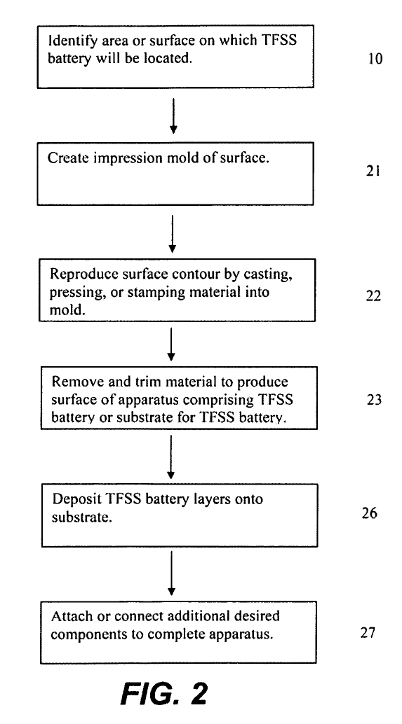

In one embodiment, the step of forming the substrate layer into the desired shape can comprise producing a physical model or mold of the desired surface. As shown in the flow chart in FIG. 2, a mold can be created 21 by modeling techniques known in the art such as molding or casting, wherein the modeling is accomplished through physical contact of the modeling substance with the identified area or surface to which the apparatus will be operationally attached 10. A complex contour of interest could be, for example, the human skull. Molds can be cast in a resin such as epoxy or plaster 22 using, for example, casting, pressing, or stamping techniques well known in the art.

A mold can then be used to produce a substrate 23 that conforms closely or substantially to the surface of the apparatus to which the TFSS battery will be applied.

Battery layers can be deposited onto the substrate 26 to form a TFSS battery, and other desired components such as electronic components and/or leads can be attached 27.

In another embodiment, the TFSS battery can be produced by depositing successive layers of materials. Deposition techniques can take place, for example, within a reaction chamber in which pressure and temperature are closely controlled. Deposition techniques for an individual layer of the TFSS battery can include physical vapor deposition, sputtering, electron beam deposition, and chemical vapor deposition (CVD) as taught by Jenson (U.S. Pat. No. 6,986,965) and Plasma-Enhanced Chemical Vapor Deposition (PECVD).

Since in certain embodiments, the apparatus comprising the TFSS battery is non-planar, the apparatus can be repositioned within the reaction chamber during deposition of thin film materials. FIG. 5 shows an example of the movement of an apparatus within a reaction chamber relative to the substrate on which the layers are being deposited by the beam. Movement of the apparatus accomplished through mechanical, hydraulic, pneumatic, or other means can be employed to keep the deposition surface in an alignment conducive to optimal material deposition.

In yet another embodiment of the invention, geometric data about the surface to which the apparatus will be operationally attached can be gathered from non-contact imaging techniques and can be used to create a mold or die that is used to form the substrate onto which the TFSS battery is constructed.

For example, in one embodiment, data about the shape of the apparatus can be collected using magnetic resonance imaging (MRI). The data collected can provide a digital map of the surface to which the apparatus comprising the TFSS battery will be operationally attached and can be used to produce the apparatus case through a numerically-controlled machining operation.

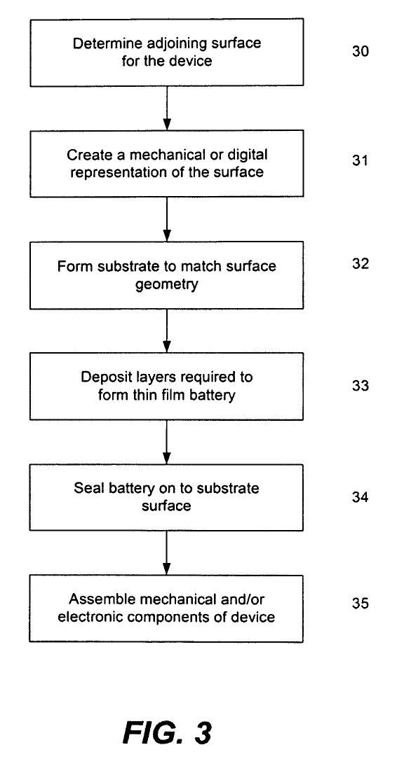

FIG. 3 shows one embodiment of the method of the invention for producing an apparatus comprising a TFSS battery. Initially, the surface onto which the apparatus is to be operationally attached is imaged or mapped 30. A mechanical or digital representation of the surface can be generated 31. A suitable substrate can then be formed to closely match the surface contour of the application area 32. The layers of the TFSS battery can then be deposited on the surface of the substrate 33. The completed TFSS battery can be sealed from the environment 34.

In another embodiment, a method for producing an apparatus comprising a TFSS battery is provided that comprises attaching an electronic component and/or a mechanical component specific to the operation of the apparatus. For example, a neurostimulation device can comprise one or more of the following: a battery control circuit, an electronic electrical pulse generator, a recharging circuit, a recharge mechanism such as an antenna or direct electrical connection, or a lead for transmitting the electrical pulse to an area of the human body in need of therapy.

The apparatus can comprise additional electronic and/or mechanical components that can be positioned on the surface of the substrate or of the TFSS battery as required by the function of the apparatus 35 (FIG. 3).

In addition to deposition on pure substrates, deposition on battery enclosures, circuit boards, and photovoltaic cells are also known in the art and can be employed. Bates (U.S. Pat. No. 5,512,147) discloses the deposition of a battery on a semi-conductor chip, and Jenson (U.S. Pat. No. 6,805,998) discloses a similar technique for forming a battery on a photovoltaic cell or the back of a liquid crystal display panel. In both of these examples, the substrate onto which the thin film battery has been built is a flat two-dimensional (planar) surface.

FIG. 4 is an illustration of a prior art thin film battery (Excellatron, Atlanta, Ga.) deposited onto a substrate. The substrate 40 has a layer of protective, insulating material 41 deposited directly onto it. An electrically conductive film is applied to function as the cathode current collector 42, and extends to a region that will allow electrical connection of other components of the apparatus. The cathode material 43 is then deposited onto a pre-determined area of the film. The electrolyte film 44 is deposited onto the cathode to an extent which encapsulates the cathode material but allows a portion of the current collector 42 to remain exposed. The anode material 45, such as lithium metal, is then deposited onto an adjacent area of similar size and geometry to the cathode 43. An anode current collector 46 comprising an electrically conductive material is deposited over the anode, extending to the insulating material 41 to provide an area of contact for connection to other components of the apparatus, but not contacting the cathode current collector 42. A sealing material 47 to isolate the battery components from the environment is applied to the layered structure while allowing portions of the cathode current collector 42 and anode current collector 46 to remain exposed.

FIG. 5 shows an embodiment of the method of the present invention for producing a TFSS battery. The methods described previously in FIG. 4 have been modified to produce an apparatus 10 comprising a TFSS battery 20 that has complex surface geometry dictated by the surface of interest.

In this embodiment, a portion of the cathode layer is aligned with the anode layer so that ions can flow between them through the layer of electrically conducting intercalation material. For example, the anode layer and/or the layer of electrically conducting intercalation material can have the same footprint as the cathode layer and be separated by the electrolyte layer through which ions can flow.

FIG. 6 illustrates a method for moving and positioning of an apparatus comprising a TFSS battery relative to a material deposition beam to achieve optimal layer formation. The reaction chamber 10 provides the reduced pressure and appropriate temperature for the deposition process. The material beam source 20 is position within the chamber. The apparatus case 30, which serves functionally as the battery substrate, is mounted on shaft attached to motor 40. The motor is fixed to a carriage 50 which travels on a track 60. Through rotation of the apparatus by means of the motor 40 and motion along the track 60, the apparatus can be position relative to the beam to achieve optimal deposition of the desired material 70.

An application site can be selected, for example, on the basis of its proximity to a therapy or treatment area as would be the case for a medical device comprising a TFSS battery of the invention. For example, a medical device comprising a TFSS battery can be employed in repairing compound fractures through distraction osteogenesis.

In other embodiments, the application site for an apparatus comprising a TFSS battery can be chosen to provide an anchoring point for the apparatus. For example, a prominent bone or set of bones (e.g., the clavicle) can be used for stabilizing the position of a defibrillator or pacemaker that comprises a TFSS battery.

In still another embodiment, the application site for a medical device comprising a TFSS battery can be chosen for reasons known in the art to be associated with device performance. For example, a medical device such as a deep brain stimulator can be located on the surface of the skull to minimize the length of the electrical leads extending to the brain. Another example is the surface of the upper palate of the mouth, which can be chosen to provide interaction with the tongue in a human interface control device.

The following examples are offered by way of illustration and not by way of limitation.

### 6. EXAMPLES

### 6.1 Example 1

### Human Interface Device

This example describes an apparatus comprising a TFSS battery that enables a person with disabilities or an individual who does not have free use of hands (e.g., owing to a bulky suit or protective clothing, as in the case of an astronaut, a deep sea diver or a person in a chemical protection suit), to control a computer or machine.

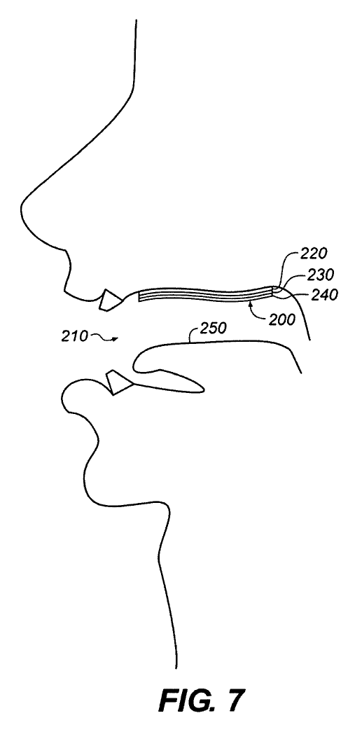

FIG. 7 depicts the use of a human interface device comprising a TFSS battery. The apparatus 200 can be constructed by first forming the substrate to the desired contour of the user's upper palate of the mouth 210. Many materials are known in the art that are suitable for use in the human mouth and that can be used as the substrate material. These include polymers such as polyethylene and TEFLON®, and metals such as stainless steel, or ceramics.

An impression of the upper palate of the mouth can be taken to capture the exact surface contour. The impression can then be used to form or mold the substrate through a casting or pressing operation. Molding of the substrate can be accomplished using, for example, standard orthodontic molding techniques known in the art such as those typically used to construct orthodontic appliances such as braces.

The layers that comprise the thin film battery 220 can be sputtered, reactively formed, reacted, evaporated, laser ablated, reactively sputtered, lithographically deposited, or printed onto the apparatus 200 by techniques previously described herein and well known in the art. A barrier film can be deposited, for example, to isolate the power source from the environment.

Electronic components 230 and a human interface device 240 such as a joystick or touch pad (see, e.g., Salem, U.S. Pat. No. 6,222,524; Moise, U.S. Pat. No. 7,071,844; and Dordick, U.S. Pat. No. 5,689,246) that can be manipulated with the tongue 250 can be connected operationally to the electronic circuit 230 or a joystick-like device as described by Salem, U.S. Pat. No. 6,222,524.

A connection can also be provided for recharging in the case where the TFSS battery comprises secondary or rechargeable cells. This can be accomplished through a direct electrical connection or through radio-frequency coupling through an antenna. Either can be accessed when the apparatus is removed from the user's mouth.

### 6.2 Example 2

### Neurostimulation Device

This example describes an apparatus comprising a TFSS battery for providing electrical stimulation directly to specific sections of the brain in a technique known as deep brain stimulation. Unlike the apparatus described in Example 1, the neurostimulator cannot be removed for recharging because it is implanted under the scalp. In this example, the TFSS battery can be used as a rechargeable (secondary) battery in the neurostimulation device along with the standard art-known control circuitry and components to enable transcutaneous recharging.

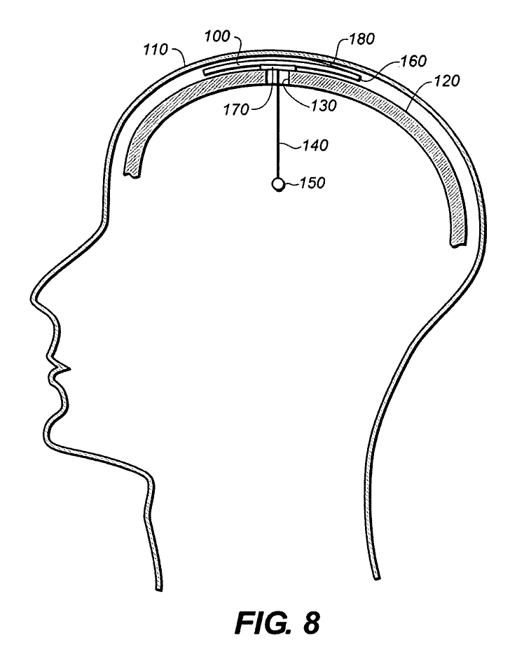

FIG. 8 provides an example of a deep brain stimulation device comprising a TFSS battery. The apparatus 100 is implanted beneath the scalp 110 on the surface of the skull 120. Preparation of the apparatus surface 100 to exactly match the contour of the skull section onto which the apparatus will be disposed can be accomplished, e.g., through preparation of a mold or by imaging of the surface of the skull through techniques such as three-dimensional tomography.

For example, three-dimensional tomography can be used to create a digital image of the skull surface. The data can be used in a computerized numerically controlled (CNC) machining operation that uses standard methods to produce an apparatus 100 that matched the skull surface 120. In another embodiment, the three dimensional digital image can be used to produce a mold through conventional machining methods known in the art. The apparatus 100 can then be formed by vacuum forming, pressing, casting, or other techniques known in the art for forming materials using a mold.

A burr hole in the skull 130 provides access for the lead 140 and stimulation electrode 150 to the brain. A battery 160 is deposited on the surface of the apparatus 100 and conforms to the complex shape of the apparatus 100. The layers required to produce the thin film battery 100 can be sputtered, reactively formed, reacted, evaporated, laser ablated, reactively sputtered, lithographically deposited or printed onto the substrate using art-known techniques. A barrier film can then be deposited to isolate the power source from the environment. The electronic circuits 170 controlling the pulse generator and battery are located within the apparatus which extends into the burr hole 130. An antenna 180 for receiving RF energy to recharge the battery can be located on or near the surface of the apparatus 100.

Conventional medical devices known in the art that are disposed to a distant area of the body such as the abdomen, and that comprise power sources are typically connected electrically by conventional wiring. For example devices providing electrical stimulation for the management of back pain can be located in areas such as the clavicle or abdomen with the leads delivering the stimulation extending from the apparatus to the target nerves located along the spinal column. The apparatus described in this example reduces electrical losses due to ohmic resistance in the electrical leads. By utilizing the TFSS battery as provided herein, the apparatus described in this example, additional surgical procedures required to implant both the apparatus and electrical leads can be eliminated.

### 6.3 Example 3

### A Medical Device Incorporating a TFSS Battery

This example describes an apparatus incorporating an embodiment of the TFSS battery. According to this embodiment, the battery is formed on a substrate than can be a portion of a medical device. The substrate can be formed to fit the contour of the surface onto which the apparatus is to be disposed. In an implantable medical device, the contoured surface may be that of a bone or organ. In the case of distractive osteogenesis, the apparatus can comprise a motor and a linear actuator to alter the alignment of a fracture during the healing process. It can be advantageous, in some embodiments, to reduce the volume of the apparatus by contouring it to match the bone surface. The TFSS battery provided herein can be incorporated into the apparatus to match the bone surface geometry.

### 6.4 Example 4

### A Non-Medical Apparatus Incorporating a Thin Film, Solid State Battery

This example describes several non-medical apparatuses that can incorporate an embodiment of the TFSS battery. For example, non-medical applications can include sensors built or attached directly onto the surface of a motor or engine that can be powered by an embodiment of the TFSS battery.

Embodiments of the TFSS battery can also be used, for example to power photovoltaic devices. Jenson (U.S. Pat. No. 6,805,998) discloses photovoltaic devices that are constructed onto the surface of a helmet (e.g., a soldier's helmet) to enable communication or act as a chemical sensor in a battlefield situation. Such photovoltaic devices can store energy in a TFSS battery that can be deposited directly on the surface of the helmet, thus reducing weight and volume when compared with conventional power storage devices.

According to this embodiment, the layers of the TFSS battery can comprise polymeric insulating materials such as glasses, ceramics, or polymers, cathode reactive materials such as manganese dioxide of other metal or mixed metal oxides, electrode separation materials including polymers such as polytetrafluoroethylene, or ionically conductive glasses such as lithium phosphorusoxynitride.

Additional layers of anodic materials including group IA elements such as lithium, conductive layers which can comprise metals such as nickel, copper, or mixed metal alloys, and insulative protective layers including polymers such as polyethylene, TEFLON®, parylene, or other biocompatible materials.

The TFSS battery can be affixed or bound to the surface of the substrate through the deposition process. Methods of depositing the individual battery layers can include DC magnetron sputtering, RF sputtering, reactive formation, evaporation, reaction, or ablation. Additionally, layers can be printed, sprayed, molded, cast, or spun on to enable construction of the battery.

### 6.5 Example 5

### TFSS Battery in Photovoltaic Array

The contoured TFSS battery can be operationally connected to a photovoltaic array that is capable of providing energy for recharging the TFSS battery (see, e.g., Jenson, U.S. Pat. No. 6,805,998). The TFSS battery can be affixed, for example, to the hood, trunk lid, or roof of an automobile. The automotive body panel is formed into a complex contour by means of stamping or molding to provide a substrate surface. The TFSS battery layers can then be deposited onto the complex shape to provide an energy storage component. An encapsulation and insulation layer can then be applied to the TFSS battery.

Using techniques known in the art, a photovoltaic array or other direct energy conversion device can then be applied over the TFSS battery-based energy storage device. The completed system can be electrically attached, for example to an automobile to power a variety of devices such as cooling fans, starting circuits, communication devices, and other similar applications.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

All references cited herein are incorporated herein by reference in their entirety and for all purposes to the same extent as if each individual publication, patent or patent application was specifically and individually indicated to be incorporated by reference in its entirety for all purposes.

The citation of any publication is for its disclosure prior to the filing date and should not be construed as an admission that the present invention is not entitled to antedate such publication by virtue of prior invention.

What is claimed is:

1. A thin film solid state (TFSS) battery comprising:
i. a substrate layer comprising an upper surface and a lower surface; and
ii. a multi-layer cell, the multi-layer cell comprising:
i. a layer of electrically conductive material comprising an upper surface and a lower surface;
ii. a first terminus layer comprising electrically conductive material, a first exposed terminus, an upper surface and a lower surface, wherein the first exposed terminus is capable of functioning as an electrical connection;
iii. a cathode layer comprising electrically conducting intercalation material, an upper surface and a lower surface;
iv. an electrolyte layer comprising an upper surface and a lower surface;
v. an anode layer comprising electrically conductive, chemically active material, an upper surface and a lower surface, wherein the anode layer is aligned with the cathode layer thereby allowing ion flow between the anode layer and the cathode layer through the electrically conducting intercalation material; and
vi. a second terminus layer comprising electrically conductive material, a second exposed terminus, an upper surface and a lower surface wherein the second exposed terminus is capable of functioning as an electrical connection.

2. The TFSS battery of claim 1 wherein:
i. the lower surface of the layer of electrically conductive material is disposed on the upper surface of the substrate layer;
ii. the lower surface of the first terminus layer is disposed on the upper surface of the layer of electrically conductive material;
iii. the lower surface of the cathode layer is disposed on the upper surface of the first terminus layer so that the exposed terminus of the first terminus layer is exposed;
iv. the lower surface of the electrolyte layer is disposed on the upper surface and sides of the cathode layer;
v. the lower surface of anode layer is disposed on the upper surface of the electrolyte layer; and
vi. the lower surface of the second terminus layer is disposed on the upper surface of the anode layer.

3. The TFSS battery of claim 1 wherein:
i. the lower surface of the layer of electrically conductive material is disposed on the upper surface of the substrate layer;
ii. the lower surface of the first terminus layer is disposed on the upper surface of the layer of electrically conductive material;
iii. the lower surface of the anode layer is disposed on the upper surface of the first terminus layer so that the exposed terminus of the first terminus layer is exposed;
iv. the lower surface of the electrolyte layer is disposed on the upper surface and sides of the anode layer;
v. the lower surface of cathode layer is disposed on the upper surface of the electrolyte layer; and
vi. the lower surface of the second terminus layer is disposed on the upper surface of the cathode layer.

4. The TFSS battery of claim 1 comprising:
i. a sealing layer comprising non-conductive, protective material, wherein:
i. the sealing layer seals the upper surface of the second terminus layer and exposed edges of layers disposed beneath the second terminus layer; and
ii. the first exposed terminus and the second exposed terminus are not sealed by the sealing layer.

5. The TFSS battery of claim 1 wherein the layer of electrically conductive material is the substrate layer.

6. The TFSS battery of claim 1 wherein the upper surface of the substrate layer comprises an insulating layer.

7. The TFSS battery of claim 1 wherein the upper surface of the first terminus layer comprises an insulating layer.

8. The TFSS battery of claim 1 comprising a plurality of multi-layer cells, wherein:
i. each of the first terminus layers of each multi-layer cell of the plurality is connected in series or in parallel to at least one other first terminus layer of a multi-layer cell of the plurality, and
ii. each of the second terminus layers of each multi-layer cell of the plurality is connected in series or in parallel to at least one other second terminus layer of a multi-layer assembly of the plurality.

9. A method for producing a TFSS battery that conforms to a contour of interest comprising the steps of:
i. Mapping the contour of interest;
ii. Recording the shape of the contour of interest;
iii. Acquiring data from the recording that describes the contour of interest;
iv. Producing a representation of the contour of interest;
v. Determining a desired shape for the substrate layer from the data describing the contour of interest:
vi. Forming the substrate layer into the desired shape, wherein the substrate layer has an upper surface and a lower surface; and
vii. Forming a multi-layer cell, the multi-layer cell comprising:
i. a layer of electrically conductive material comprising an upper surface and a lower surface;
ii. a first terminus layer comprising electrically conductive material, a first exposed terminus, an upper surface and a lower surface, wherein the first exposed terminus is capable of functioning as an electrical connection;
iii. a cathode layer comprising electrically conducting intercalation material, an upper surface and a lower surface;
iv. an electrolyte layer comprising an upper surface and a lower surface;
v. an anode layer comprising electrically conductive, chemically active material, an upper surface and a lower surface, wherein the anode layer is aligned with the cathode layer thereby allowing ion flow between the anode layer and the cathode layer through the electrically conducting intercalation material; and
vi. a second terminus layer comprising electrically conductive material, a second exposed terminus, an upper surface and a lower surface wherein the second exposed terminus is capable of functioning as an electrical connection.

10. The method of claim 9 wherein:
i. the lower surface of the layer of electrically conductive material is disposed on the upper surface of the substrate layer;
ii. the lower surface of the first terminus layer is disposed on the upper surface of the layer of electrically conductive material;
iii. the lower surface of the cathode layer is disposed on the upper surface of the first terminus layer so that the exposed terminus of the first terminus layer is exposed;
iv. the lower surface of the electrolyte layer is disposed on the upper surface and sides of the cathode layer;
v. the lower surface of anode layer is disposed on the upper surface of the electrolyte layer; and
vi. the lower surface of the second terminus layer is disposed on the upper surface of the anode layer.

11. The method of claim 9 wherein:
i. the lower surface of the layer of electrically conductive material is disposed on the upper surface of the substrate layer;
ii. the lower surface of the first terminus layer is disposed on the upper surface of the layer of electrically conductive material;
iii. the lower surface of the anode layer is disposed on the upper surface of the first terminus layer so that the exposed terminus of the first terminus layer is exposed;
iv. the lower surface of the electrolyte layer is disposed on the upper surface and sides of the anode layer;
v. the lower surface of cathode layer is disposed on the upper surface of the electrolyte layer; and
vi. the lower surface of the second terminus layer is disposed on the upper surface of the cathode layer.

12. The method of claim 9, wherein the multi-layer cell comprises:
i. a sealing layer comprising non-conductive, protective material, wherein:
i. the sealing layer seals the upper surface of the second terminus layer and exposed edges of layers disposed beneath the second terminus layer; and
ii. the first exposed terminus and the second exposed terminus are not sealed by the sealing layer.

13. An apparatus comprising:
an electrically powered device; and
a TFSS battery operatively connected to the electrically powered device, wherein the TFSS battery conforms to a contour of interest and wherein the TFSS battery comprises:
i. a substrate layer comprising an upper surface and a lower surface; and
ii. a multi-layer cell, the multi-layer cell comprising:
i. a layer of electrically conductive material comprising an upper surface and a lower surface;
ii. a first terminus layer comprising electrically conductive material, a first exposed terminus, an upper surface and a lower surface, wherein the first exposed terminus is capable of functioning as an electrical connection;
iii. a cathode layer comprising electrically conducting intercalation material, an upper surface and a lower surface;
iv. an electrolyte layer comprising an upper surface and a lower surface;
v. an anode layer comprising electrically conductive, chemically active material, an upper surface and a lower surface, wherein the anode layer is aligned with the cathode layer thereby allowing ion flow between the anode layer and the cathode layer through the electrically conducting intercalation material; and
vi. a second terminus layer comprising electrically conductive material, a second exposed terminus, an upper surface and a lower surface wherein the second exposed terminus is capable of functioning as an electrical connection.

14. The apparatus of claim 13 wherein:
i. the lower surface of the layer of electrically conductive material is disposed on the upper surface of the substrate layer;
ii. the lower surface of the first terminus layer is disposed on the upper surface of the layer of electrically conductive material;
iii. the lower surface of the cathode layer is disposed on the upper surface of the first terminus layer so that the exposed terminus of the first terminus layer is exposed;
iv. the lower surface of the electrolyte layer is disposed on the upper surface and sides of the cathode layer;
v. the lower surface of anode layer is disposed on the upper surface of the electrolyte layer; and
vi. the lower surface of the second terminus layer is disposed on the upper surface of the anode layer.

15. The apparatus of claim 13 wherein:
i. the lower surface of the layer of electrically conductive material is disposed on the upper surface of the substrate layer;
ii. the lower surface of the first terminus layer is disposed on the upper surface of the layer of electrically conductive material;
iii. the lower surface of the anode layer is disposed on the upper surface of the first terminus layer so that the exposed terminus of the first terminus layer is exposed;
iv. the lower surface of the electrolyte layer is disposed on the upper surface and sides of the anode layer;
v. the lower surface of cathode layer is disposed on the upper surface of the electrolyte layer; and
vi. the lower surface of the second terminus layer is disposed on the upper surface of the cathode layer.

16. The apparatus of claim 13 wherein the TFSS battery comprises:
i. a sealing layer comprising non-conductive, protective material, wherein:
i. the sealing layer seals the upper surface of the second terminus layer and exposed edges of layers disposed beneath the second terminus layer; and
ii. the first exposed terminus and the second exposed terminus are not sealed by the sealing layer.

17. The apparatus of claim 13 wherein the electrically powered device is selected from the group consisting of cardiac rhythm management device, neurostimulation device, pump for dispensing drug or pharmaceutical composition, diagnostic sensor; regeneration and repair device; tissue repair device, and human interface device.

18. An apparatus comprising:
An electricity-generating device; and
A TFSS battery operatively connected to the electricity-generating device wherein the TFSS battery conforms to a contour of interest and wherein the TFSS battery comprises:
a substrate layer comprising an upper surface and a lower surface; and
i. a multi-layer cell, the multi-layer cell comprising:
i. a layer of electrically conductive material comprising an upper surface and a lower surface;
ii. a first terminus layer comprising electrically conductive material, a first exposed terminus, an upper surface and a lower surface, wherein the first exposed terminus is capable of functioning as an electrical connection;
iii. a cathode layer comprising electrically conducting intercalation material, an upper surface and a lower surface;
iv. an electrolyte layer comprising an upper surface and a lower surface;
v. an anode layer comprising electrically conductive, chemically active material, an upper surface and a lower surface, wherein the anode layer is aligned with the cathode layer thereby allowing ion flow between the anode layer and the cathode layer through the electrically conducting intercalation material; and
vi. a second terminus layer comprising electrically conductive material, a second exposed terminus, an upper surface and a lower surface wherein the second exposed terminus is capable of functioning as an electrical connection.

19. The apparatus of claim 18 wherein:
i. the lower surface of the layer of electrically conductive material is disposed on the upper surface of the substrate layer;
ii. the lower surface of the first terminus layer is disposed on the upper surface of the layer of electrically conductive material;
iii. the lower surface of the cathode layer is disposed on the upper surface of the first terminus layer so that the exposed terminus of the first terminus layer is exposed;
iv. the lower surface of the electrolyte layer is disposed on the upper surface and sides of the cathode layer;
v. the lower surface of anode layer is disposed on the upper surface of the electrolyte layer; and
vi. the lower surface of the second terminus layer is disposed on the upper surface of the anode layer.

20. The apparatus of claim 18 wherein:
i. the lower surface of the layer of electrically conductive material is disposed on the upper surface of the substrate layer;
ii. the lower surface of the first terminus layer is disposed on the upper surface of the layer of electrically conductive material;
iii. the lower surface of the anode layer is disposed on the upper surface of the first terminus layer so that the exposed terminus of the first terminus layer is exposed;
iv. the lower surface of the electrolyte layer is disposed on the upper surface and sides of the anode layer;
v. the lower surface of cathode layer is disposed on the upper surface of the electrolyte layer; and
vi. the lower surface of the second terminus layer is disposed on the upper surface of the cathode layer.

21. The apparatus of claim 18 wherein the TFSS battery comprises:
i. a sealing layer comprising non-conductive, protective material, wherein:
i. the sealing layer seals the upper surface of the second terminus layer and exposed edges of layers disposed beneath the second terminus layer; and
ii. the first exposed terminus and the second exposed terminus are not sealed by the sealing layer.

22. The apparatus of claim 18 wherein the electricity-generating device is selected from the group consisting of a photovoltaic array, a DC power supply, and a charging battery.
